(19) United States
(12) Patent Application Publication
(10) Pub. No.: US 2019/0257326 A1
(43) Pub. Date: Aug. 22, 2019

(54) Method For Mass-Customization And Multi-Axial Motion With A Knit-Constrained Actuator

(71) Applicant: The Regents of The University of Michigan, Ann Arbor, MI (US)

(72) Inventors: Sean AHLQUIST, Ann Arbor, MI (US); Jonathan Wesley MCGEE, Ann Arbor, MI (US)

(21) Appl. No.: 16/279,099

(22) Filed: Feb. 19, 2019

Related U.S. Application Data
(60) Provisional application No. 62/632,032, filed on Feb. 19, 2018.

(51) Int. Cl. F15B 15/10

(52) U.S. Cl. CPC F15B 15/103

(57) ABSTRACT

A knit-constrained actuator system having a pneumatic actuator system configured to output a pneumatic pressure; one or more elastomeric actuators configured to receive and physically respond to the pneumatic pressure; and a knitted sleeve formed over the one or more elastomeric actuators. The knitted sleeve mechanically constraining the elastomeric actuator(s). The knitted sleeve being of a predetermined stitch configuration to achieve an actuated motion of the elastomeric actuator(s).

### CROSS-REFERENCE TO RELATED APPLICATIONS

This application claims the benefit of U.S. Provisional Application No. 62/632,032 filed on Feb. 19, 2018. The entire disclosure of the above-referenced application is incorporated herein by reference.

### FIELD

The present disclosure relates to a method for mass-customization and multi-axial motion with a knit-constrained actuator.

### BACKGROUND AND SUMMARY

This section provides background information related to the present disclosure which is not necessarily prior art. This section also provides a general summary of the disclosure, and is not a comprehensive disclosure of its full scope or all of its features.

Generally, the present teachings relate to the characterization of knit-constrained actuators for bending and twisting, as opposed to linear actuation such as in a McKibben actuator. Commonly, bending actuation is accomplished through the combination of an elastomeric air chamber and an inextensible, but flexible, strain-limiting layer, such as woven fiberglass cloth. A swelling constraint is additionally added by winding high strength fibers, such as Kevlar, around the air chamber. The uni-axial or bi-axial direction of winding for the swelling constraint is utilized to induce either twisting or bending, respectively.

In comparison to robotic systems with rigid mechanical joints, such soft mechanisms for motion are ideal for human interaction, though currently lack a comparable level of articulation and predictability. A particular challenge in soft robotics is the ability to isolate a particular bending movement within the length of a single actuator, and additionally to combine different motions within a singular element. In the work of Galloway et al. (2013) and Maeda-York et al. (2014), this is accomplished through a multi-layer, multi-component assembly, either by the application of a constraining sleeve to isolate bending, or by the assembly of multiple segmented actuators to introduce different bending motions.

In the present teachings, such differentiated articulation is generated through a single knitted constraint utilizing continuous variation in stitch structure. Industrial dual-bed weft-knitting is proposed as a unique solution for producing a differentiated, textile reinforcing sleeve for a pneumatic actuator.

In some embodiments of the present teachings, weft-knitting allows for significant differentiation in the structure of a textile at the scale of the stitch. The density of stitches can be dramatically altered within a single course and between courses, referred to as multi-gauge knitting. Where the gauge of a machine defines the number of needles per inch, multi-gauging infers the ability to alter the number of stitches knitted per inch. For instance, an all needle structure can be combined with 1×1 knitting, or knitting on every other needle (FIG. 2A). This creates a local differentiation in the stretch of the textile.

It is important to understand, though, the counterintuitive nature of such a condition. An increased density of stitches introduces more stretch as there are more loops of material allowing for a greater geometric reconfiguration when an external force is applied.

In another embodiment, differentiating the number of stitches between courses, referred to as shaping or goring, allows for the production of a seamless non-planar textile geometry (FIG. 2B).

In another embodiment of the present teachings, the two beds of a weft-knitting machine allow for the efficient production of seamless tubular structures. Elaborate topologies of seamlessly interconnected tubular structures through weft-knitting have been shown in the research for complex textile hybrid architectures, structures formed of interacting tension- and bending-active elements.

The research in textile hybrid structures utilizes course-wise tubular textiles, while, as mentioned previously, the present teachings include pneumatic actuators, which focus in more depth on the development of wale-wise tubular knits. Of most importance, the wale-wise strategy allows for an infinite number of sleeves to be integrated within a single continuous textile, along with the seamless introduction of different materials between sleeves.

The present teachings employ the development of seamless pneumatically-actuated systems whose motion is controlled by the combination of differentially-knitted textiles and standardized thin-walled silicone tubing. In some embodiments, a fundamental material strategy is employed that addresses challenges ranging from soft robotics to pneumatic architecture.

Research in soft robotics seeks to achieve complex motions through non-mechanical monolithic systems, comprised of highly articulated shapes molded with a combination of elastic and inelastic materials. Inflatables in architecture focus largely on the active structuring of static forms, as facade systems or as structured envelopes. An emerging use of pneumatic architecture proposes morphable, adaptive systems accomplished through differentiated mechanically interconnected components.

The present teachings encompass a wide array of capabilities in motion and geometric articulation, which are accomplished through the design of knitted sleeves that generate a series of actuated “elbows.” As opposed to molding silicone bladders, differentiation in motion is generated through the more facile ability of changing stitch structure, and shaping of the knitted textile sleeve, which constrains the standard silicone tubing. The relationship between knit differentiation, pneumatic pressure, and the resultant motion profile is studied initially with individual actuators, and ultimately in propositions for larger seamless assemblies.

As opposed to a cellular study of individual components, the present teachings include structures with multi-scalar articulation, from fiber and stitch to overall form, composed into seamless, massively deformable architectures.

In other words, the present teachings provide for the construction of a soft actuator using a knitted sleeve as the constraint mechanism that improves the ability to articulate the full range of motion (including extension, bending and twisting), integrate multiple actuators into a single seamless system, utilize high performance yarns in order to operate the actuator at an extremely wide range of pressures thus achieving a wide range of motion, and automate the production of customizable soft actuators.

Generally, the method comprises the use of custom knitted multi-material textiles that serve as the constraint mechanisms for standardized silicon tubing. Two different knitting strategies are utilized with this method to achieve an actuated “elbow” system. The course-wise constraint uses a combination of “shaping” and integration of high performance and highly elastic yarns. The welt-wise constraint utilizes a “multi-gauging” technique to introduce varied knit densities at the “elbow.” Knits are programmed to seamlessly integrate multiple sleeves as a part of the knit manufacturing process.

Generally, this method is applicable to the field of soft robotics. This includes their use as grippers as a part of larger robotic systems. Moreover, this includes the development of independent robotic systems, such as exoskeletons and wearables, serving as assistive technologies for movement—for application such as limiting fatigue and strain, or as therapeutic devices for re-gaining abilities for movement and muscle control.

This method provides greater articulation of movement for soft actuators through an automated manufacturing process where multiple actuators can be integrated into a single interconnected system. Utilizing a knitted constraint mechanism allows for both individual actuators to be tailored to specific performance requirements and the entire system tailored to fit a particular application. Allowing for the use of standardized silicon tubing removes the costly and inefficient process of manufacturing form-work and producing specialized bladders.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A illustrates a course-wise tubular knit according to the principles of the present teachings.

FIG. 1B illustrates a wale-wise tubular knit according to the principles of the present teachings.

FIG. 2A illustrates fundamental knitting techniques utilized for articulating the knitted tubular sleeves including multi-gauging according to the principles of the present teachings.

FIG. 2B illustrates fundamental knitting techniques utilized for articulating the knitted tubular sleeves including shaping or goring according to the principles of the present teachings.

FIG. 3 is a photograph of the architecture of the pneumatic control system according to the principles of the present teachings.

FIGS. 4A-4F are diagrams comparing wale-wise and course-wise strategies for knitting differentiated sleeves according to the principles of the present teachings.

FIGS. 5A-5B illustrate a comparison of different elbow constructions in a course-wise tubular knit using all polyester according to the principles of the present teachings.

FIGS. 5C-5D illustrate a comparison of different elbow constructions in a course-wise tubular knit using inset areas of nylastic at the elbow according to the principles of the present teachings.

FIGS. 5E-5F illustrate a comparison of different elbow constructions in a course-wise tubular knit using nylastic and polyester knitted throughout the textile according to the principles of the present teachings.

FIG. 6A-6C illustrate inflation tests for single knit with four independent course-wise sleeves in a hexagonal configuration, detailing inflation of all bladders which structures the surface to an approximate height of five inches according to the principles of the present teachings.

FIGS. 6D-6I illustrate inflation tests for single knit with four independent course-wise sleeves in a hexagonal configuration, phasing the inflation from one bladder to the next which produces a sideways movement of approximately one inch per cycle according to the principles of the present teachings.

FIG. 7 is a simulation showing input table for spring rest length data to approximate inextensible and extensible areas of the elbow of the inflated cylinder according to the principles of the present teachings.

FIG. 8 illustrates detail of inflated wale-wise tubular knit, showing (a) multi-gauge 1×1 stitches defining the “backbone” of the knit, (b) extensible region with all needle knitting, and (c) strain limiting region with multi-gauge knitting of stitches every 4th needle according to the principles of the present teachings.

FIG. 9 illustrates the overlay of analysis of rotation, with sampling at a step of 3.0 psi up to 50 psi, for an actuator with an un-articulated wale-wise tubular sleeve according to the principles of the present teachings.

FIGS. 10A-10D illustrate overlay of analysis of rotation, with sampling at a step of 3.0 psi up to 50 psi, for actuators with an articulated region of 33, 61, 93 and 125 stitches wide according to the principles of the present teachings.

FIG. 11 is a photograph showing detail of inflated wale-wise tubular knit, showing (a) shaped area of the knit that minimizes bending motion, and (b) un-shaped region where significant bending motion occurs according to the principles of the present teachings.

FIG. 12A illustrates overlay of analysis of rotation, with sampling at a step of 3.0 psi up to 80 psi, for an actuator with an un-articulated wale-wise tubular sleeve according to the principles of the present teachings.

FIG. 12B illustrates overlay of analysis of rotation, with sampling at a step of 3.0 psi up to 80 psi, for an actuator with a sleeve with more structured stitches along a certain length of the backbone of the knit according to the principles of the present teachings.

FIG. 13 is a graph of comparison of pressure to rotation angle at the end of each actuator, where the multi-gauge knits are captured in grey and the shaped knits are shown in red according to the principles of the present teachings.

FIG. 14A shows a comparison of studies between actuators, pressurized up to 80 psi, with two shaped regions where the elbow condition occurs between each of the shaped areas defined by the knit according to the principles of the present teachings.

FIG. 14B shows a comparison of studies between actuators, pressurized up to 80 psi, with three shaped regions where the elbow condition occurs between each of the shaped areas defined by the knit according to the principles of the present teachings.

FIG. 14C shows a comparison of studies between actuators, pressurized up to 80 psi, with four shaped regions where the elbow condition occurs between each of the shaped areas defined by the knit according to the principles of the present teachings.

FIG. 14D is an actuator in an articulated position according to the principles of the present teachings.

FIG. 15A illustrates the spiraling motion at 24 psi generated by shaping the body of the wale-wise sleeve in relation to the “backbone” stitches according to the principles of the present teachings.

FIG. 15B illustrates the spiraling motion at 54 psi generated by shaping the body of the wale-wise sleeve in relation to the “backbone” stitches according to the principles of the present teachings.

FIG. 15C illustrates the spiraling motion at 84 psi generated by shaping the body of the wale-wise sleeve in relation to the “backbone” stitches according to the principles of the present teachings.

FIGS. 16A-16C illustrate aggregated behavior producing natural sine wave bending motions according to the principles of the present teachings.

FIGS. 17A-17F illustrate aggregate spiraling behavior of interconnected actuators, pressurized to 80 psi according to the principles of the present teachings.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

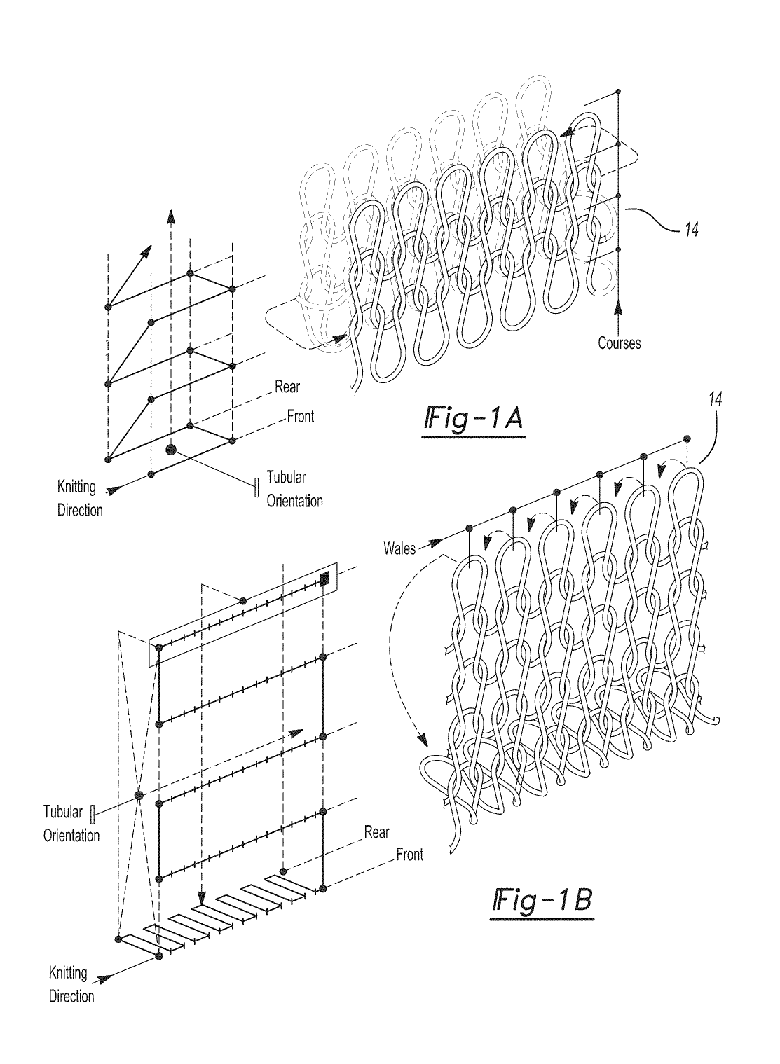

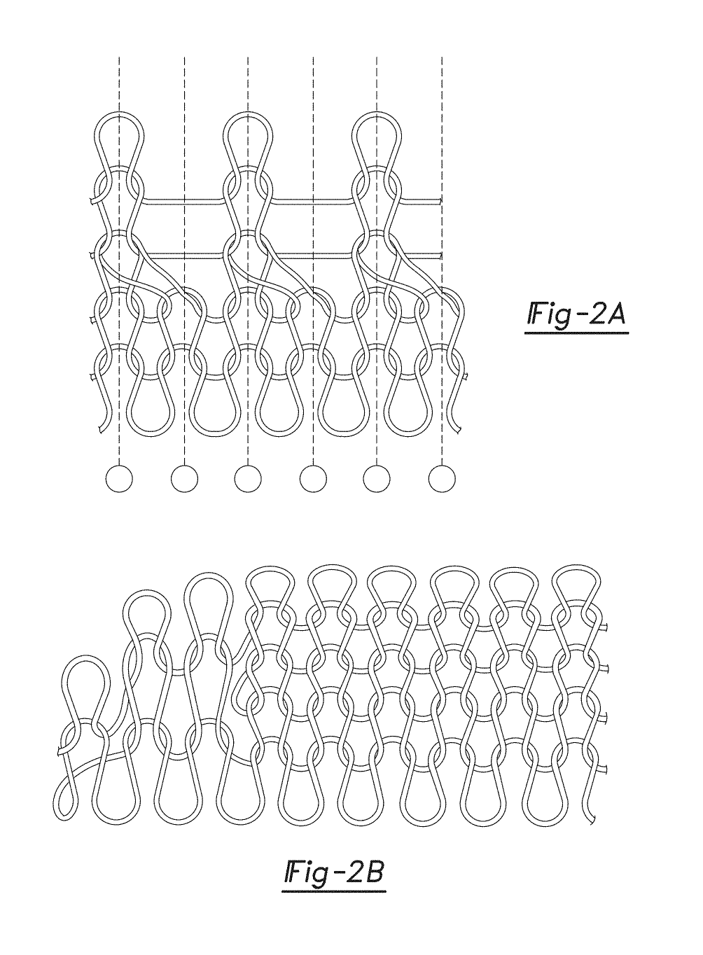

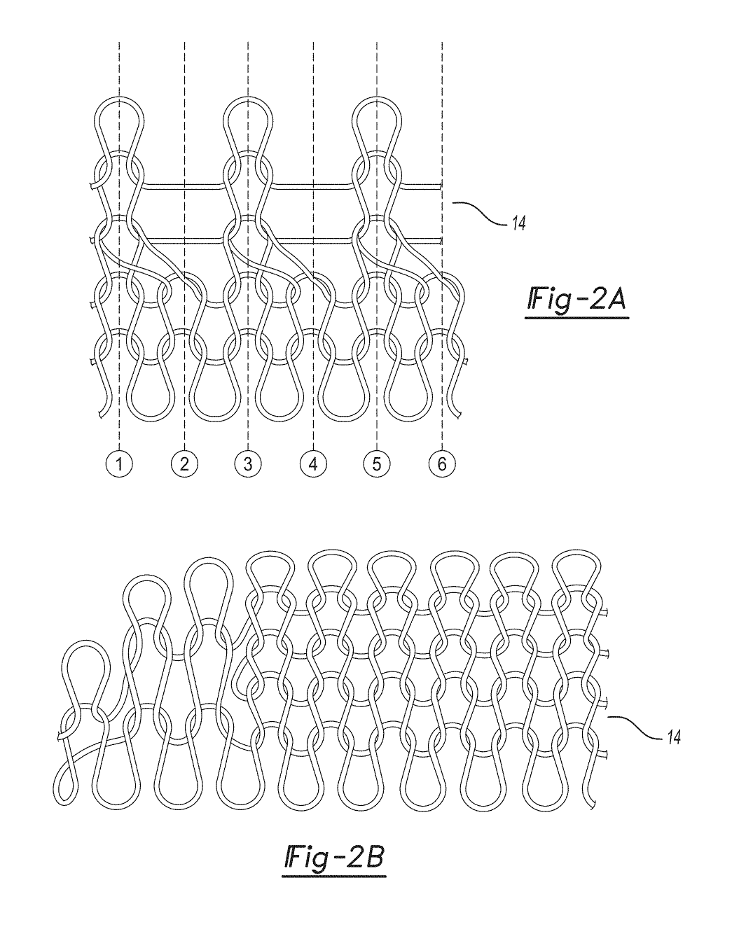

In some embodiments, the present teachings characterize a knit-constrained actuator system 10 and, more particularly, the motion behavior of knit-constrained silicone tubes 12. In some embodiments, the present teachings are particularly focused on the development of wale-wise tubular knits 14 (see FIG. 1B) as a constraining sleeve for the silicon tubing 12. The wale direction of a knit 14 refers to a horizontal loop or stitch direction, while course-wise refers to a vertical direction of the knit or the direction containing rows of stitches (see FIG. 1A). A wale-wise tubular knit 14 means the length of the sleeve is defined by the number of wales or stitches. Course-wise defines the length of the sleeves by the number of courses.

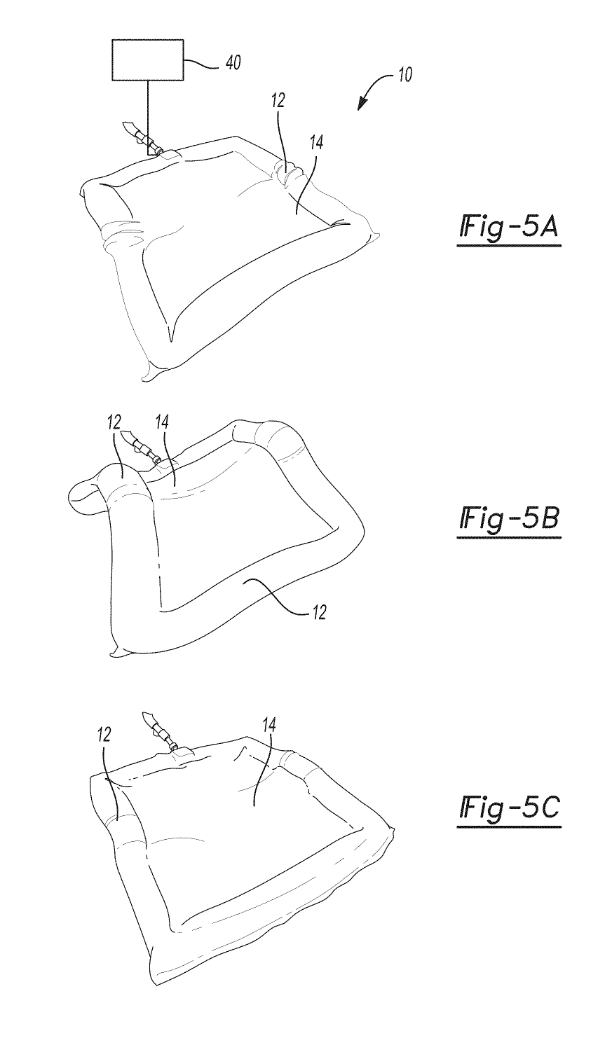

Given the asymmetry of a knitted stitch, very different strategies are needed to both construct tubular knit 14 and introduce the necessary stitch configuration and/or variations in order to produce the desired bending behavior. A range of wale-wise knit structures within a seamless sleeve 14 (see FIG. 5A and following) are explored to form an actuated “elbow.” The knit-constrained actuator is subjected to a ramping pressure profile in tests up to 80 psi to examine the full range of motion and its nonlinear behavior. While initially exploring planar motions, in some embodiments particular knits are developed to create multi-axial movements.

The knit-constrained actuator systems 10 of the present teachings exhibit the ability of the knitted constraint 14 to allow for extremely thin-walled uniform silicone tubes 12 ( 1/32″ wall thickness) to be pressurized up to ten times their working pressure. In combination with differentiation in the knit structure 14, the isotropic tubes 12 can generate a high-degree of geometric articulation while accomplishing a wide range of motion, in some cases over 360 degrees for an eight-inch long, approximately half-inch diameter actuator, when fully inflated.

In some embodiments, the present teachings advance concepts in soft robotics as well as appropriate fundamental technological developments for application to the field of pneumatic systems in architecture. First, in some embodiments, the present teachings employ the use of an elastomeric material as the vessel for inflation (i.e. tubing 12). Such is typical for actuators designed to accomplish linear, bending, and twisting motions, where a strain-limiting element is embedded within the elastomeric material. By contrast, architectural systems utilizing air to activate a closed membrane as a tensile, structural volume are made of inextensible polymer foils.

This poses a considerable distinction where the architectural pneumatic system operates as a structural system only in a singular geometric state. Projects such as PneuSystems seek to introduce geometric variability by working with interlocking pneumatic ethylene tetrafluoroethylene (ETFE) components. In a variant of the PneuSystems project, NervousEther utilized a control system that varied pressure within each pillow to drive transformation of the overall assembly. Introducing a flexible “muscle” within a pneumatic component enables the Adaptive Pneus project to alter its local geometric orientation. Investigations have also looked to mimic the material methodology and control systems for soft robotics, using geometrically differentiated molded silicone bladders, to project their potential as dynamically interactive architectural surfaces.

Previous knit-constrained pneumatic systems have focused on differentiation in knit-structure to drive the formation of a particular geometric result, while using standard elastomeric bladders.

Introducing a textile reinforcement 14 to an elastomeric bladder 12 aims to bridge the potential for a morphable, soft robotic system 10, in its range of motion and control mechanism, to be exploited as an architectural system. Industrial CNC weft-knitting, as the means for producing the textile reinforcement 14, allows for efficient production of a seamless differentiated constraint, eliminating the efforts of producing a differentiated bladder. While this research focuses largely on the characterization of individual actuators, initial prototypes are shown which exhibit the ability to embed constrained actuators within a larger textile construction. Such integration opens up an additional degree of transformability, not only focusing on the actuator motion but also the activation and gradient behavior of the surfaces in between actuators.

Pneumatic Control System

Pneumatic valves 30 of the present teachings can be roughly divided into two primary types: on/off valves, and proportional valves. Proportional valves offer the highest degree of control, and operate by translating an electrical input signal and an input air pressure into a controlled pressure at the output, within the rated flow limit. By calibrating the resulting state of the actuator to this pressure, a repeatable open loop positioning system can be created. With the addition of integrated sensing or external position feedback, a servo-pneumatic positioner can be created which can adapt to feedback such as external loads.

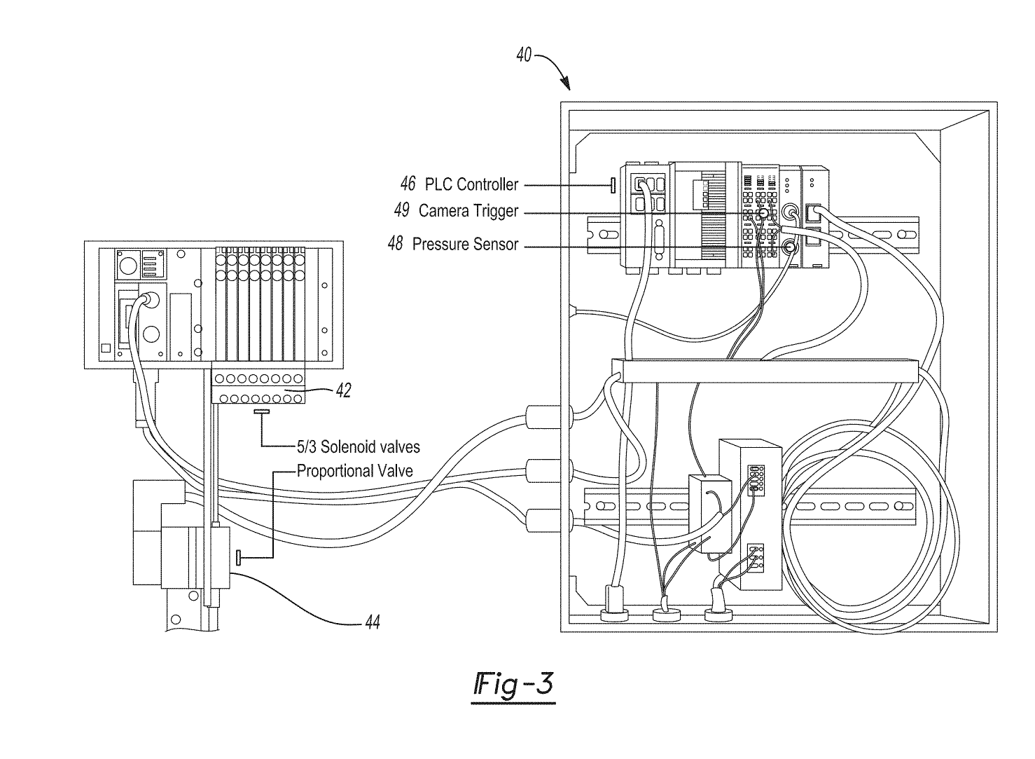

The disadvantage of proportional technology is its high cost. A typical system requires a proportional valve and an analog output channel for each pneumatic circuit (FIG. 3). An alternative, as used here in the experimental setup, is to use solenoid on/off valves 42, which are available in numerous configurations and a single proportional valve 44. On/off valves 42 operate simply by opening or closing; the downstream pressure will match the upstream pressure once the system 40 reaches steady state. By precisely controlling the “on” time of a valve 42, partial inflation states can be achieved. While an on/off control methodology is considerably cheaper per circuit, in the range of 25-50% the cost of a proportional system, it is significantly more challenging to create a continuously variable position control system. For the characterization of the knit actuators described below, a proportional system was used to control the pressure according to a calibrated input signal.

Differentiated Knit Constraints

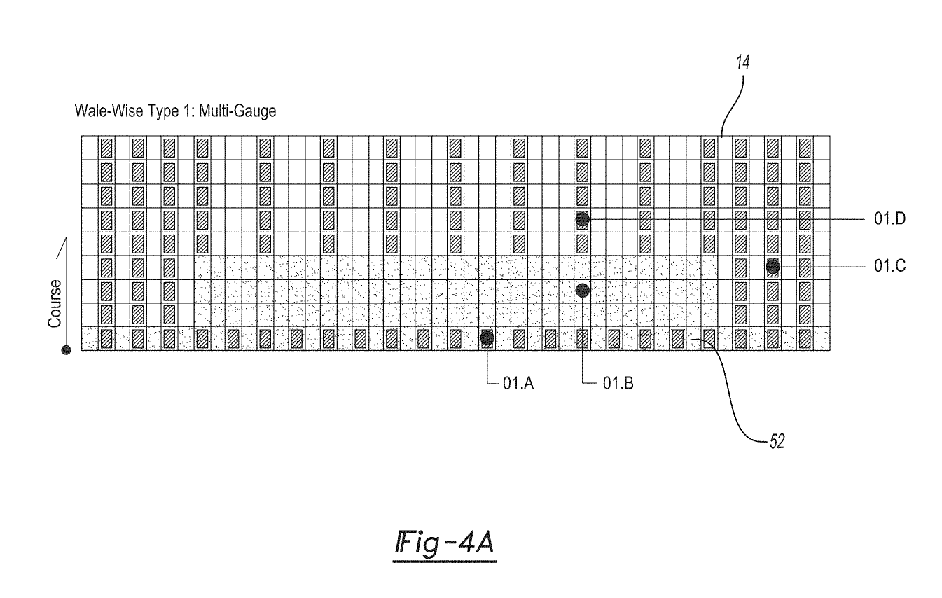

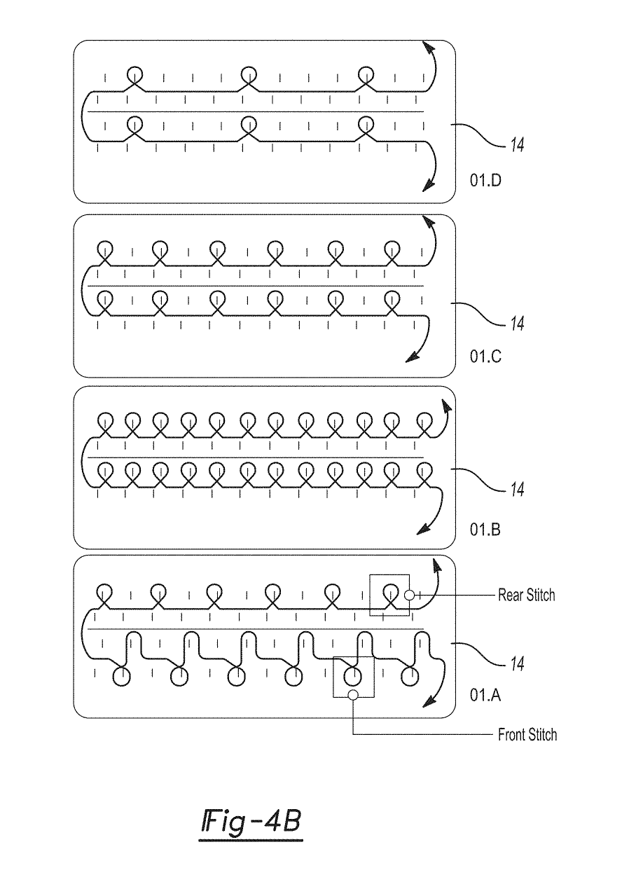

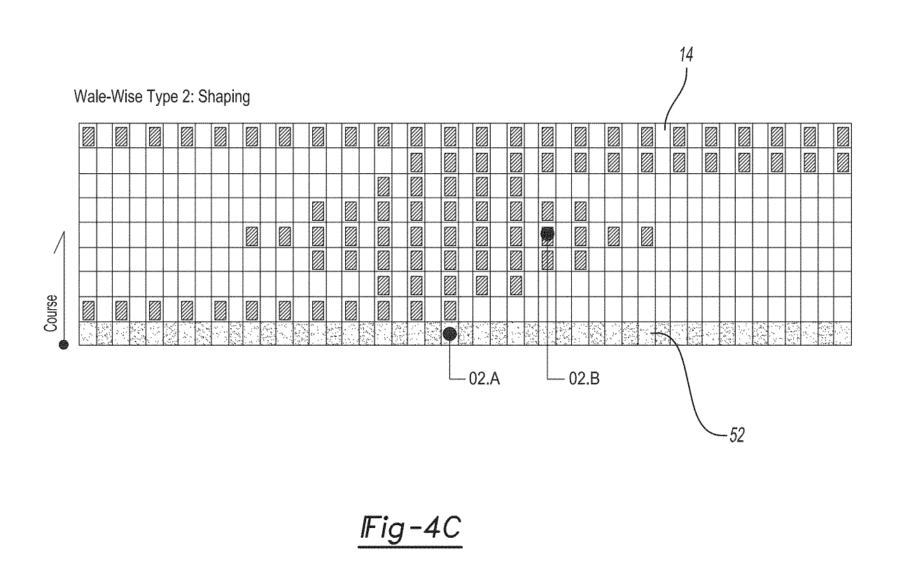

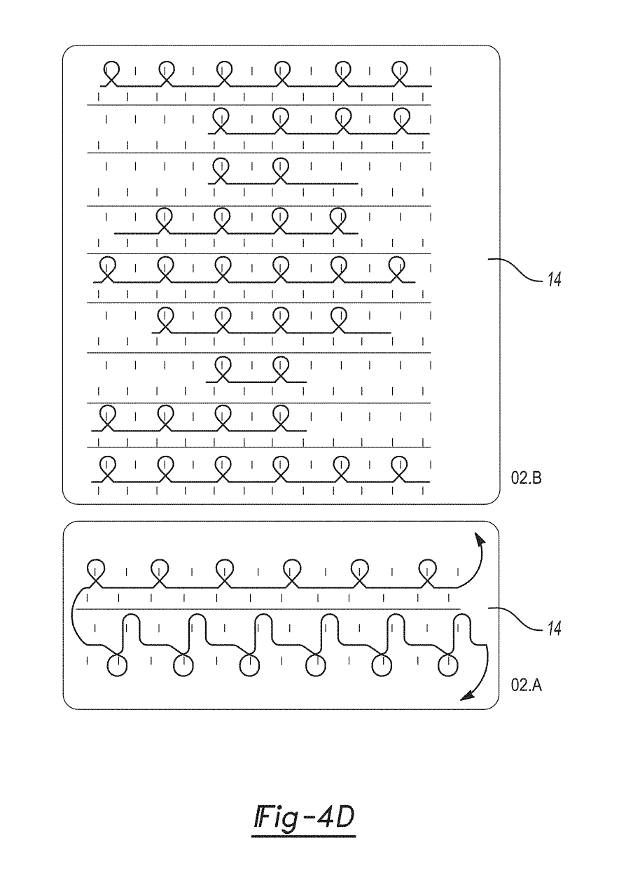

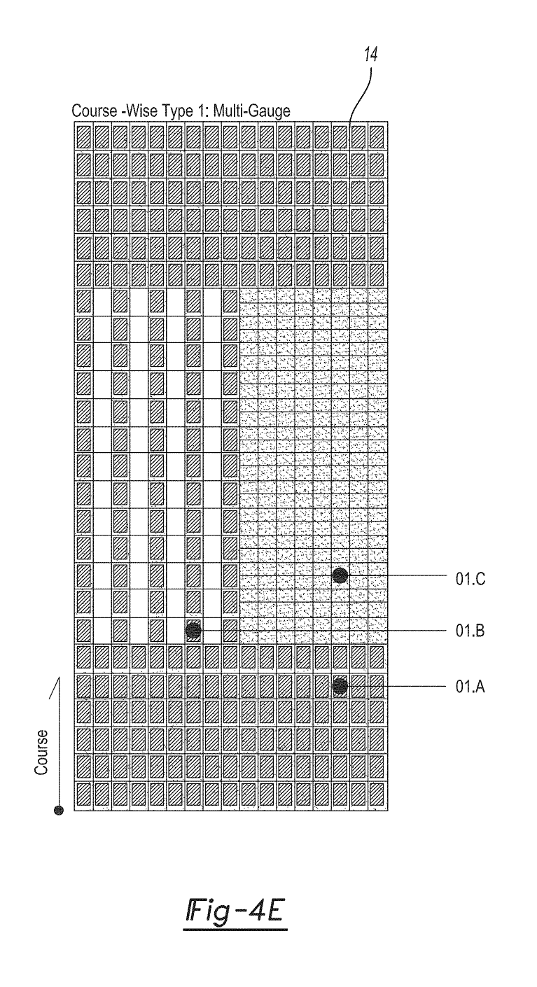

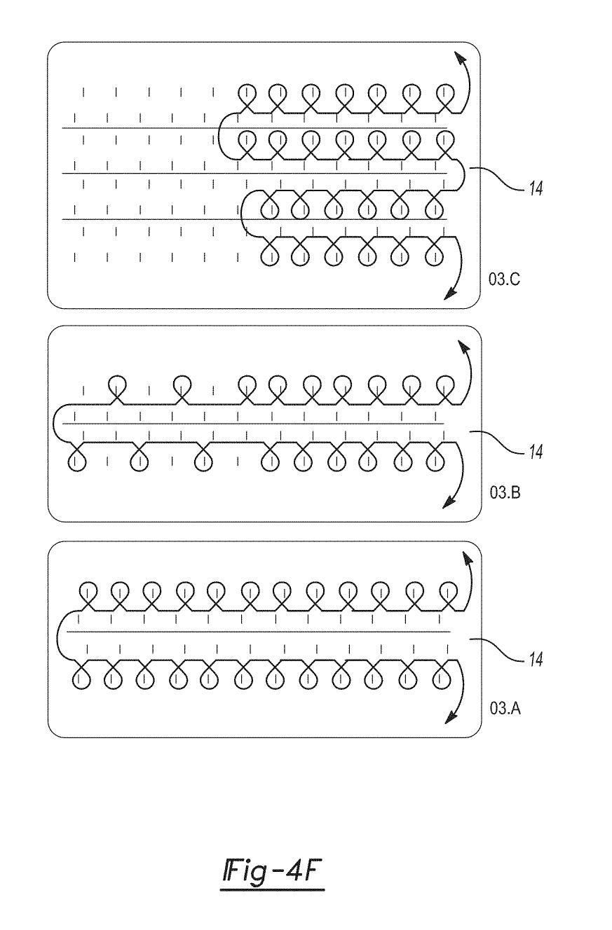

In some embodiments of the present teachings, the knitted constraints 14 are developed utilizing a STOLL 822 HP 7.2 Multi-gauge knitting machine. Whether course-wise or wale-wise, the basic strategy for generating an actuated elbow involves producing a region where there is more material on one side of the tube versus the other. This is controlled by increasing the number of stitches (or stitch density) on one side to produce the extensible region and reducing the number of stitches (or stitch density) on the other side to produce the restricting region or inner radius of the elbow (FIGS. 4A-4F). The wale-wise knits have an additional control along the backbone 52 of the knit 14, noted as condition 01.A and 02.A in FIGS. 4A-4F. This backbone 52 consists of a series of long stitches oriented in the circumferential direction of the sleeve 16. Akin to a ladder stitch, this region does not have any shear or longitudinal constraint. Thus, by itself, the backbone 52 of a wale-wise knit produces the extensible region and generates the bending motion. Further articulation within such a knit controls the location, radius, and extent of motion. Initial studies were completed with the course-wise knits, while further exploration, articulation, and examination of the welt-wise knits was undertaken during this research.

Experimental Setup

For the characterization of the knit-constrained actuator system 10, a machine vision system is incorporated into the industrial programmable logic controller (PLC) 46 (FIG. 3) which forms the basis for the pneumatic control system 40. In the experimental setup and in some embodiments, this system 40 can comprise an embedded PC running IEC 61131 standard PLC code. The PLC program controls an analog output to produce a linearly ramped pressure. The actual air pressure is measured by a secondary pressure transducer 48 attached directly to the actuator, since the proportional valve 44 used in this test is an open-loop device. The program triggers a camera 49 at regular intervals according to the change in pressure. This differs from a system where the camera is triggered at a fixed time interval, though in a perfectly linear system these should match. By using a pressure based trigger, the intent is to better capture the nonlinear sections of the inflation tests.

A custom executable software is employed to interface between the various components in the experiment. In order to facilitate high frame rate capture, the software is written in C++, utilizing the camera's SDK (Spinnaker), OpenCV, and the TwinCAT ADS protocol. The executable starts the ramping pressure profile, captures the image via a trigger in the PLC program, queries the PLC for the current pressure, and then stores pressure data along with the image. In order to reduce the storage required by the raw file capture, after the completion of a test, the executable then re-opens, compresses, and saves the images.

The images are then batch processed in an image processing software, and used to extract data for the shape of the actuator versus the recorded pressure. Currently the data is limited to the estimated angle at the end of the tube, but future work intends to gather more complex shape information, such as radius of curvature, or multi-jointed hinge measurements.

Course-Wise Studies

In some embodiments of the present teachings, the course-wise tubular knit 14 structure is used to create an actuated, stiffened boundary which subsequently forms a tensile saddle-like surface. The textiles are knitted with two ends of a high performance 725 denier/192 filament polyester yarn. The bladder is a silicone tube, Durometer (hardness) 50 Shore A, with ½ inch inside diameter, 1/16 inch wall, and a maximum operating pressure of five psi.

Because of the knitted constraint, these exemplars are able to operate in the range of 25 to 50 psi. The elbow motion is generated through two interconnected alterations in the knit structures: (i) the number of stitches are reduced, knitted as a multi-gauge 1×1 knit, to create the inextensible or restricting region, and (ii) the extensible or expandable region is formed by knitting on all needles as well as knitting two courses for every one course in the opposite side of the elbow, shown in FIG. 4—diagram 03.C.

In some embodiments, the present teachings include the utilization of different yarn combinations: (i) polyester only, (ii) polyester with bands of stitches using nylon-elastic yarn (referred to as nylastic) isolated at the elbows, and (iii) combined polyester and nylastic stitches across the entire textile, where stitch structure is varied at the elbow to express extensibility with more nylastic stitches and inextensibility with primarily polyester stitches (FIGS. 5A-5B).

In some embodiments, the present teachings employ nylastic isolated at the elbows (FIGS. 5C-5D), which generates the most significant motion being tested, up to 40 psi. This method of knitting—in knitting with a particular yarn only in isolated regions across the width of the textile—is limited for tubular structures in the course-wise direction. Referred to as intarsia, depending on the number of yarn feeders in the machine only a limited number of separate regions knitted in the course direction can be achieved.

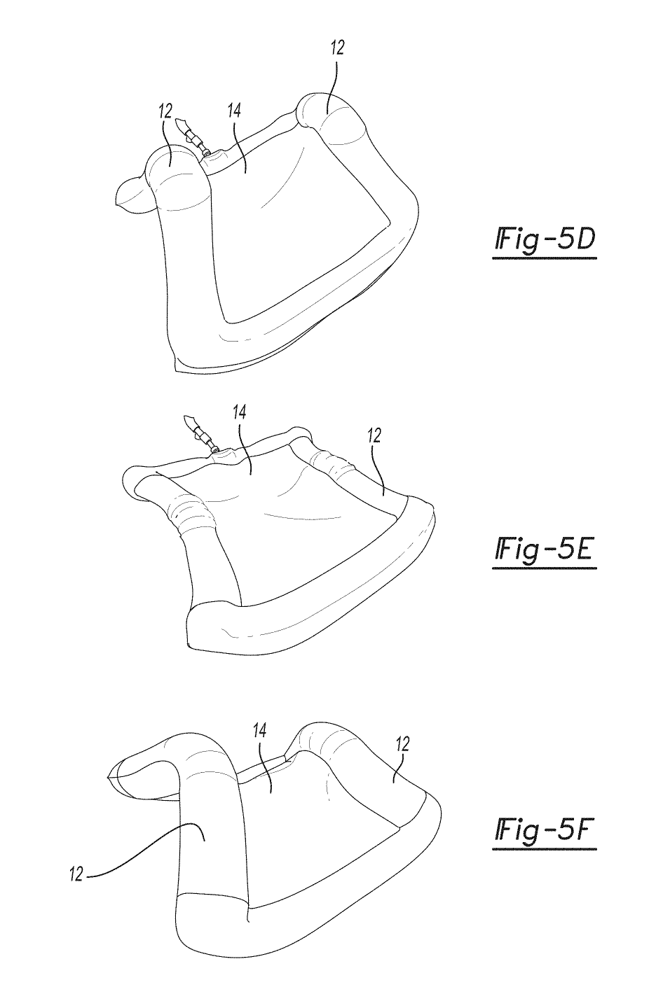

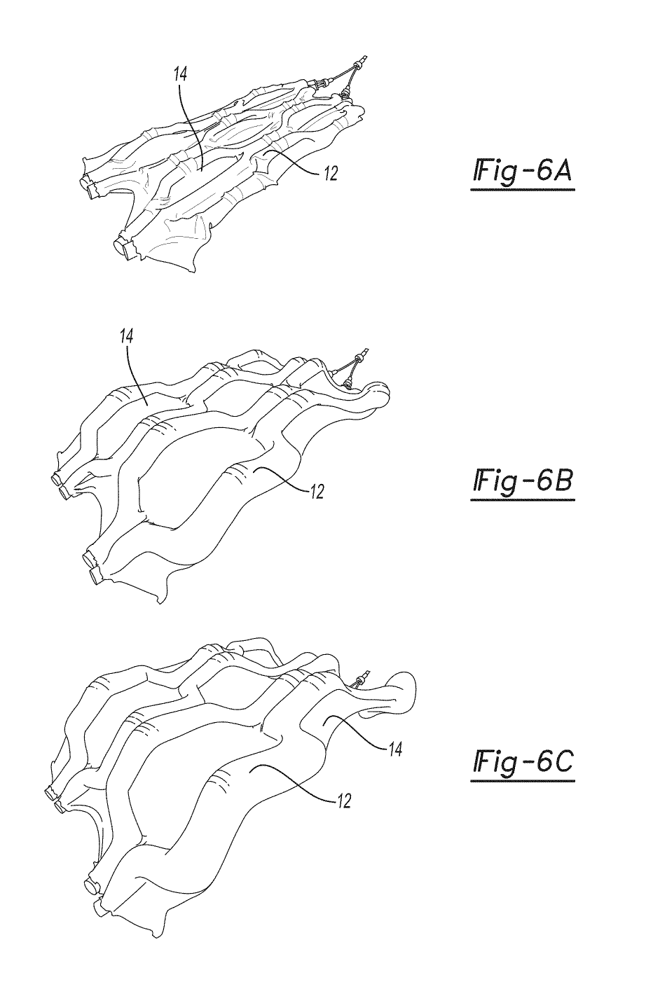

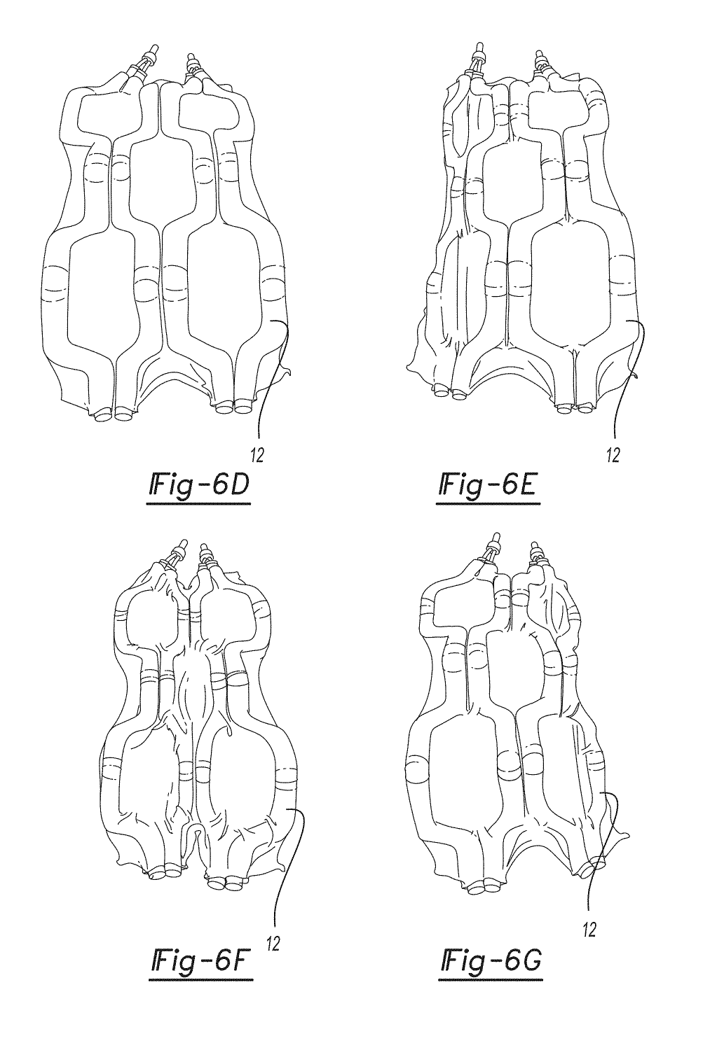

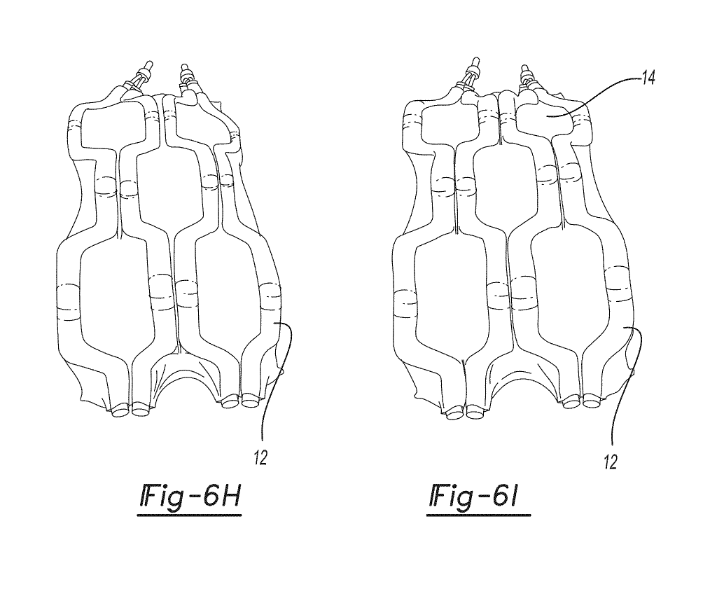

Therefore, a larger prototype of the present teachings was developed utilizing the combined polyester and nylastic strategy shown in FIGS. 5E-5F. In the larger prototype, the “breathing” nature of the textile is explored when cycling the pressure from 0 to 25 psi across the entire knit and cycling individually from bladder to bladder (FIGS. 6A-6I).

1st Order Simulation

In some embodiments, the present teachings employ a first order simulation tool. The intention for the first order simulation tool is to capture the overall behavior of the interaction between the inflated bladder and differentiated knitted sleeve 16, with minimal input for material characterization. To do so, a method is developed to encase the action of inflation and influence of constraint within a single mesh, as opposed to creating two interacting rigid body elements.

The method for applying an inflation force to a mesh is based upon the strategy used by Daniel Piker for mass-spring based physics simulation (2016). Forces are applied to the nodes of each triangular face within a mesh. The direction of the force is based upon the normal direction of the face, and its magnitude is defined by a global value times a factor of the face area.

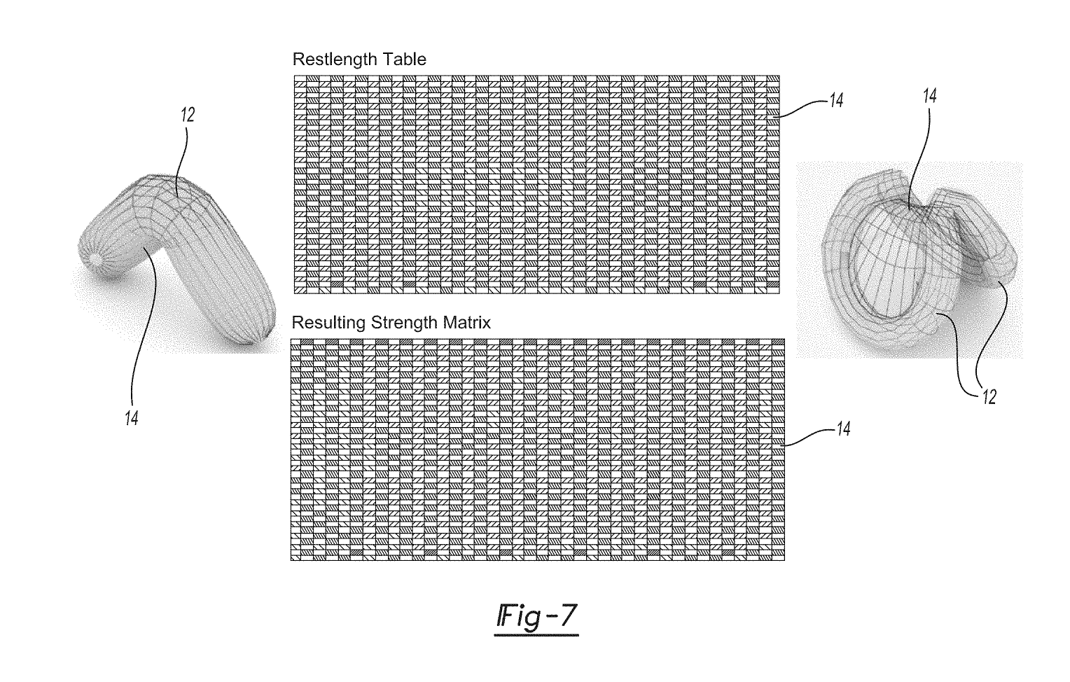

To explore the potential of a simplified design tool while approximating the material differentiation of the knitted sleeve 16, a regular quad mesh of the present teachings is employed with an overlay of differential spring lengths (FIG. 7). As opposed to a typical mass-spring based simulation, the springs strengths are non-linear, being increased as they approach their target length. This is primarily due to the area factor; whereas area increases so does the magnitude of force.

Where there are greater differences in area between faces, as what happens in the “elbow” of the mesh, the simulation can tend to “explode” where inflation forces on larger faces increase infinitely. The parameters that compute the relationship between factors defining the magnitude of inflation forces and the spring mesh itself are made to be manipulable during the form-finding process. This is critical in both visually understanding the ramifications of adjusting the individual parameters and being able to tailor their relationship for a particular topology and articulation at the “elbow” of the inflation model. Further development looks to explore the construction of non-uniform meshes where a quad-face can represent the approximation of a certain grid of stitches.

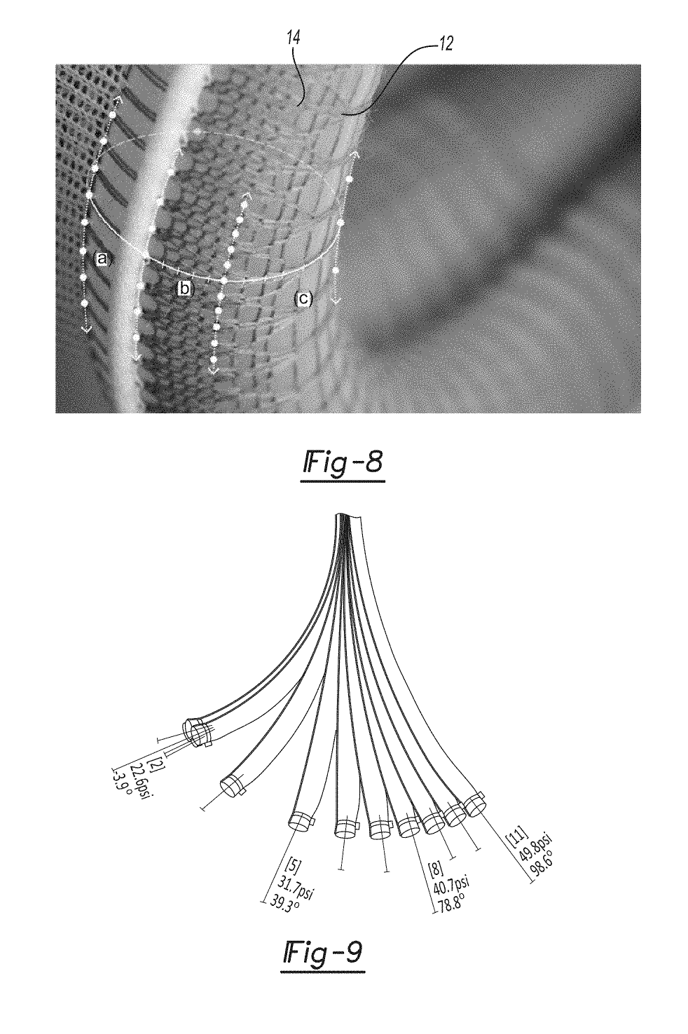

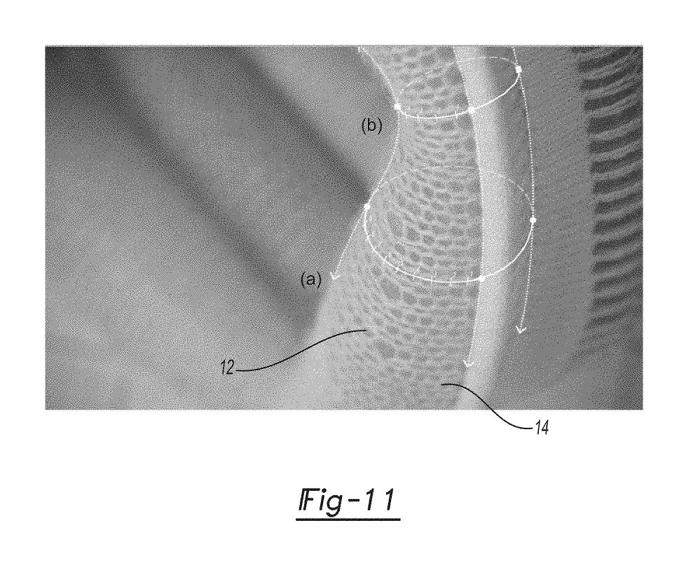

The present teachings employ two variants of the wale-wise strategy: (i) the use of multi-gauging to generate the inextensible region (FIG. 8), and (ii) the use of shaping to expand and contract the circumference of the wale-wise tube, relying on the backbone, as referred to earlier to drive the bending motion (FIG. 11).

The multi-gauge studies explore the length of the articulated region to determine the bending behavior under a range of pressures up to 50 psi on an approximately 7.5 inch long actuator. In some embodiments, the multi-gauge sleeves 16 are knitted with the same polyester yarn as the course-wise studies, but in a lighter 325 denier/22 filament weight. A silicone tube is utilized, Durometer 50 Shore A, with ¼ inch inside diameter silicone tube, 1/16 inch wall, and a maximum operating pressure of five psi.

At 50 psi, the actuator 12 is expanded to an approximate diameter of 0.72 inches, almost two times its initial 0.375 inch outer diameter. With the initial examination of a wale-wise knit with no stitch articulation at the elbow, the motion behavior is minimal. The initial un-inflated state exhibits curvature driven solely by the backbone of the wale-wise tubular knit 14. But, when the bladder is inflated the actuator geometry is mostly straight, primarily exhibiting rotation because of the degrees of freedom at the fixture (FIG. 9). The backbone of the wale-wise knit in this example is mostly ruled out from producing a bending behavior. Therefore, any articulation within the knit will isolate the bending motion to that location.

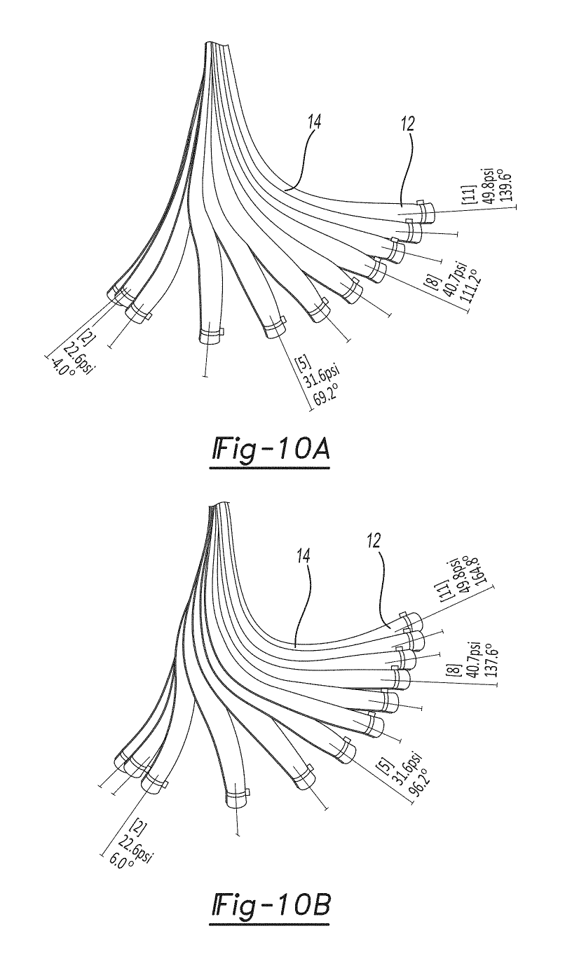

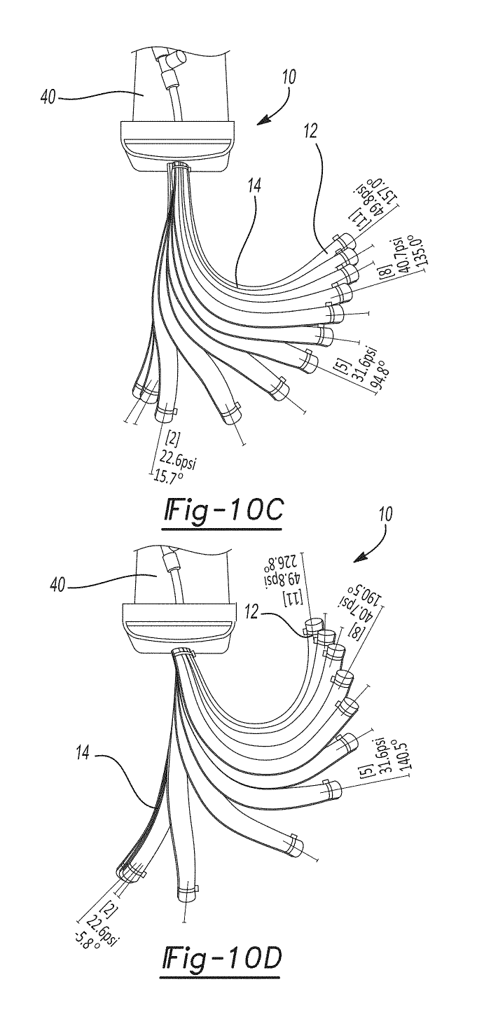

In another embodiment, articulation for the elbow is introduced by knitting all needles on one side of the elbow and knitting every fourth needle on the opposite side (as seen in FIG. 4D—diagram 02.B). The width of the articulated area is varied from sample to sample from 33 to 125 needles wide (FIG. 10). Examining the full range of movement across all samples, there is an initial “s” curvature and then a nonlinear transformation to a more natural bending motion. By approximately 30 psi, the non-articulated portion of the knit is straight and the bending geometry is concentrated in the multi-gauged area of the knit.

In another embodiment, the use of shaping is utilized to drive the bending behavior (FIG. 11), which are designed to operate at higher pressure (tested up to 80 psi), while using a thinner walled bladder and a higher strength yarn. The bladder is a silicone tube, Durometer 50 Shore A, with ¼ inch inside diameter, 1/32 inch wall, and a maximum operating pressure of 10 psi. The sleeves 16 are knitted with a Kevlar yarn.

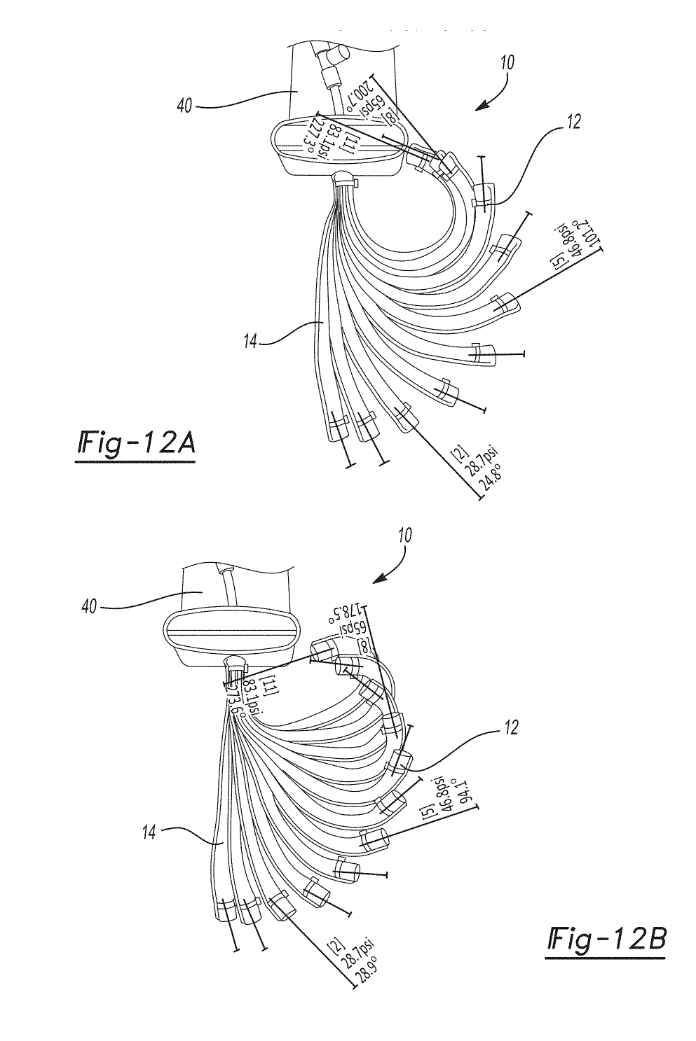

The unarticulated actuator exhibits very different behavior from the previous studies. In this embodiment, the backbone of the wale-wise knit is clearly the driving factor in generating the bending motion (FIGS. 12A-12B). This is confirmed in the testing of a knit where the stitches along a certain length of the backbone of the sleeve 16 are more highly structured. The bending motion is significantly constrained in this region (FIG. 12B).

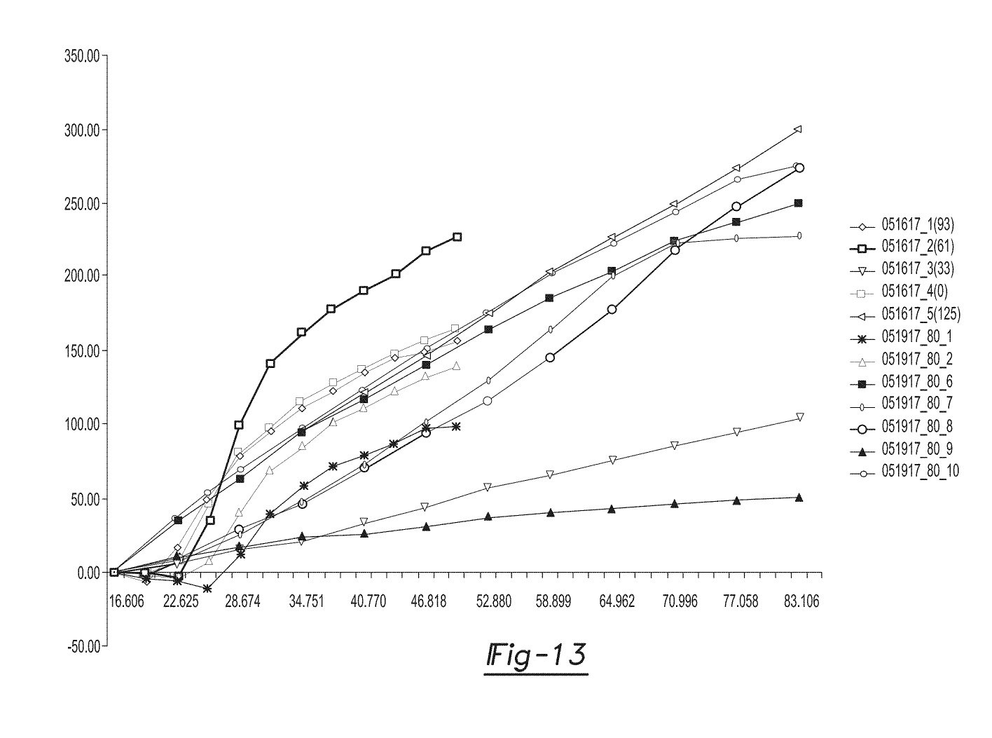

Shown across the array of tests, the overall motion behavior is more linear in comparison to the multi-gauge prototypes (FIG. 13). One critical factor which drives the distinction between these two sets of studies is the size of the sleeve 16 in comparison to the outside diameter of the silicone tube. In the un-articulated sleeve 16 shown in some figures, at 50 psi, the diameter of the actuator is 0.375 inches, only 1.2 times bigger than the 0.3125 inch outer diameter of the silicon tubing. This is in comparison to the approximately two times factor for the previous studies. The expansion of the silicone tube is constrained in the circumferential direction, allowing it more ability to expand along the extensible region of the knit—the backbone.

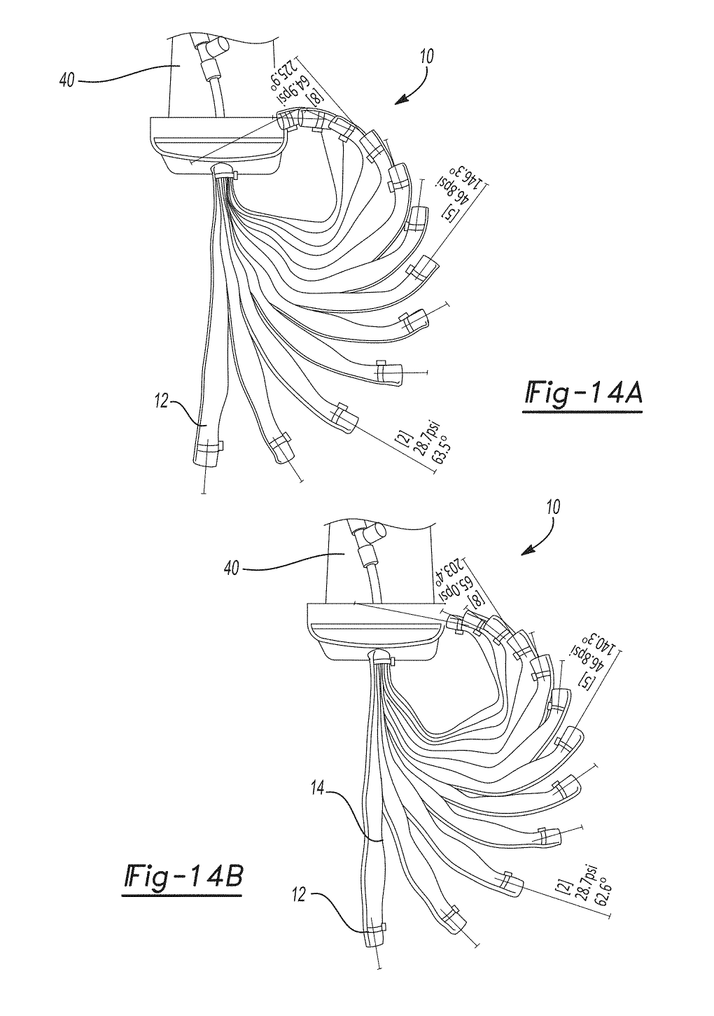

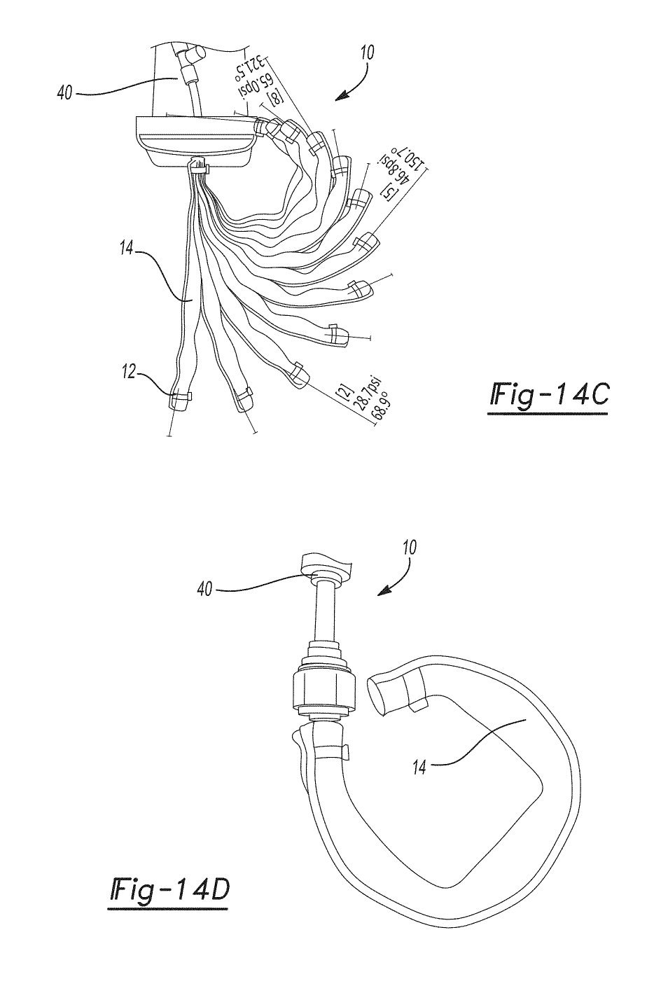

In some embodiments of the present teachings, to isolate the bending motion, a series of shaped regions are introduced along the length of the knit. The shaped regions introduce more material, thus allowing the silicone tube to expand in its diameter, limiting the effect of the backbone to generate a bending motion (FIG. 14). This results in a very sharp and concentrated curvature in the un-shaped regions.

Previous studies with shaped actuators show a unique combination of range of movement and degrees of freedom. In the work by Polygenorinos et al. on a robotic hand assistive device, multiple degrees of freedom are achieved through a “multi-segment actuator” (2015). Combinations of clockwise and counterclockwise fiber reinforcements bonded with the elastic and strain-limiting components are tailored to produce such levels of articulation. The examples described herein show the ability to capture the degrees of freedom all within the structure of the knitted sleeve 16.

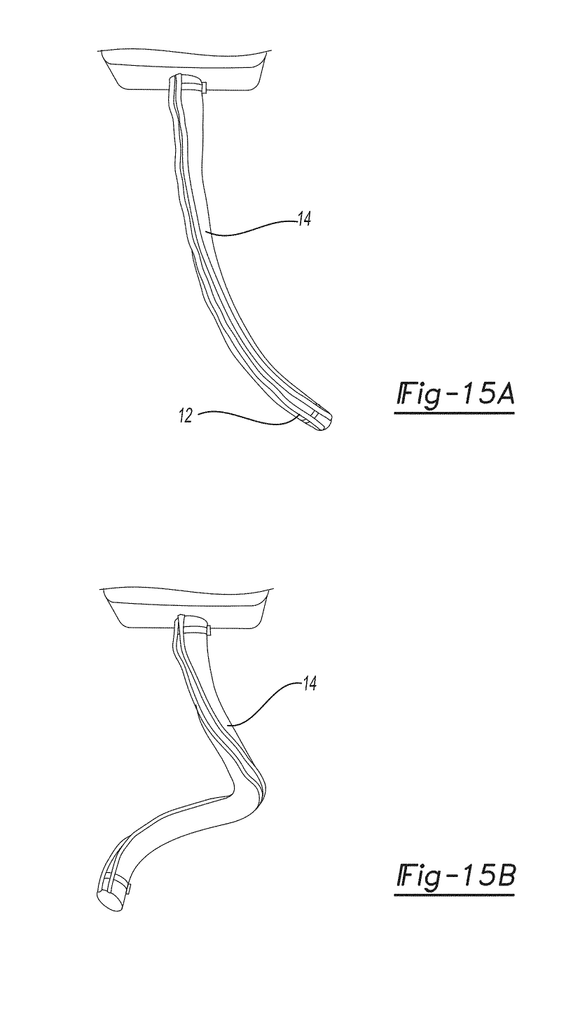

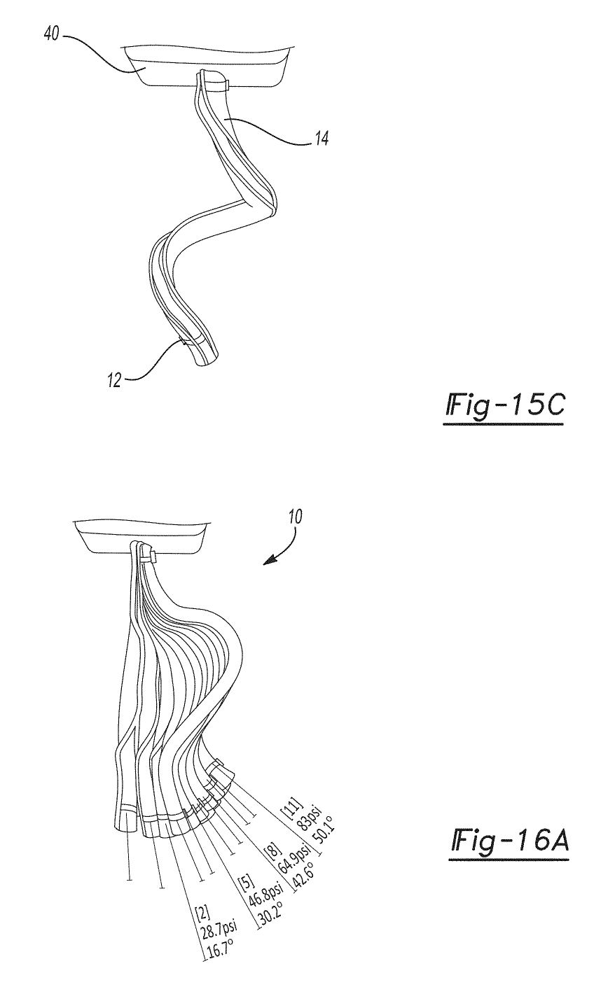

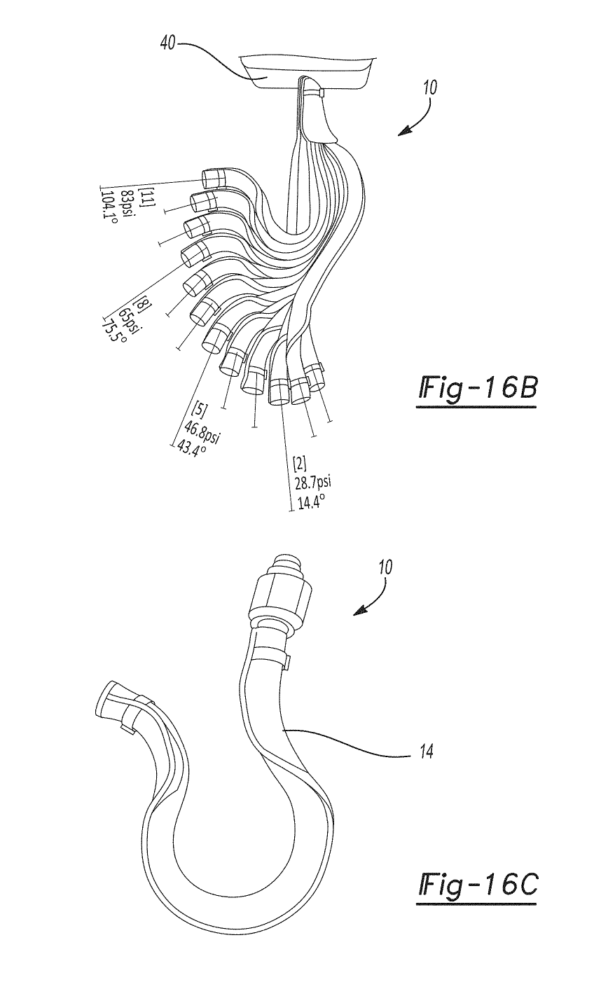

Expanding upon the aggregated behavior within a single actuator, additional knit characteristics of the present teachings are constructed within a single knitted constraint to produce a wider array of movement. Spiraling is achieved by a continuously shaping along the length of the wale-wise knit (FIG. 15). While this uses the method of shaping, it produces an actuator with a constant cross-section, unlike the actuators shown in FIG. 14. A sine-wave motion is produced based upon the sample shown in FIG. 12A. To shift the location of the “backbone” from one side of the tubular sleeve 16 to another, a section of the sleeve 16 is knitted on the opposite needle bed of the knitting machine (FIGS. 16A-16C).

The present teachings employ the ability to assemble multiple actuators within a seamless system. This exposes the key capacity of machine knitting in creating seamless, 3D, multi-material textile systems. The initial concept is to resemble the basic structural strategy of a textile hybrid system: the interaction of a bending-active boundary with a tensile, form-active surface.

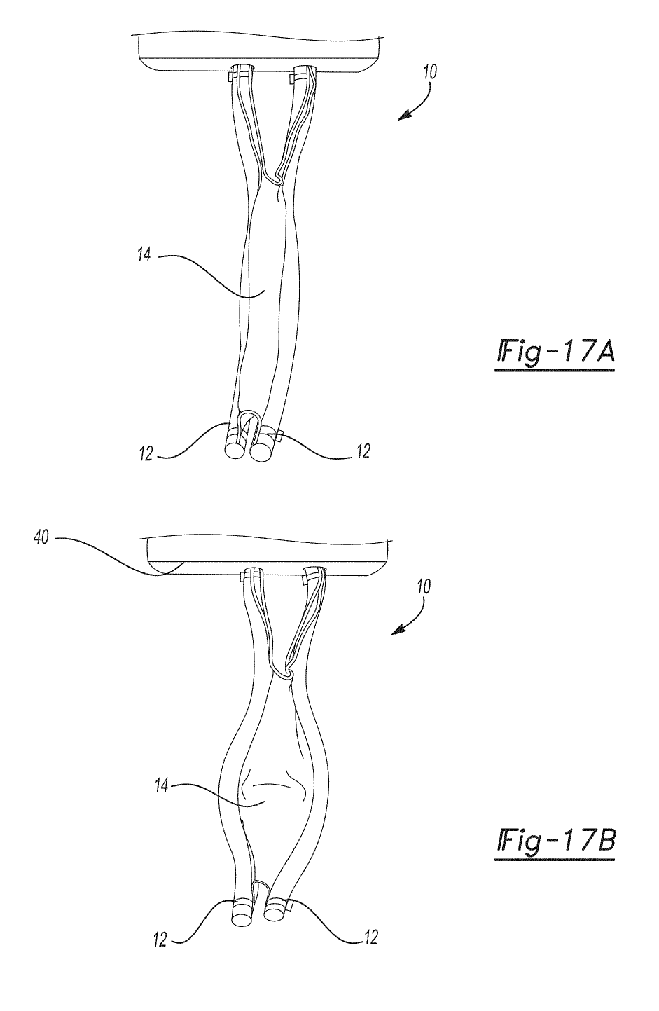

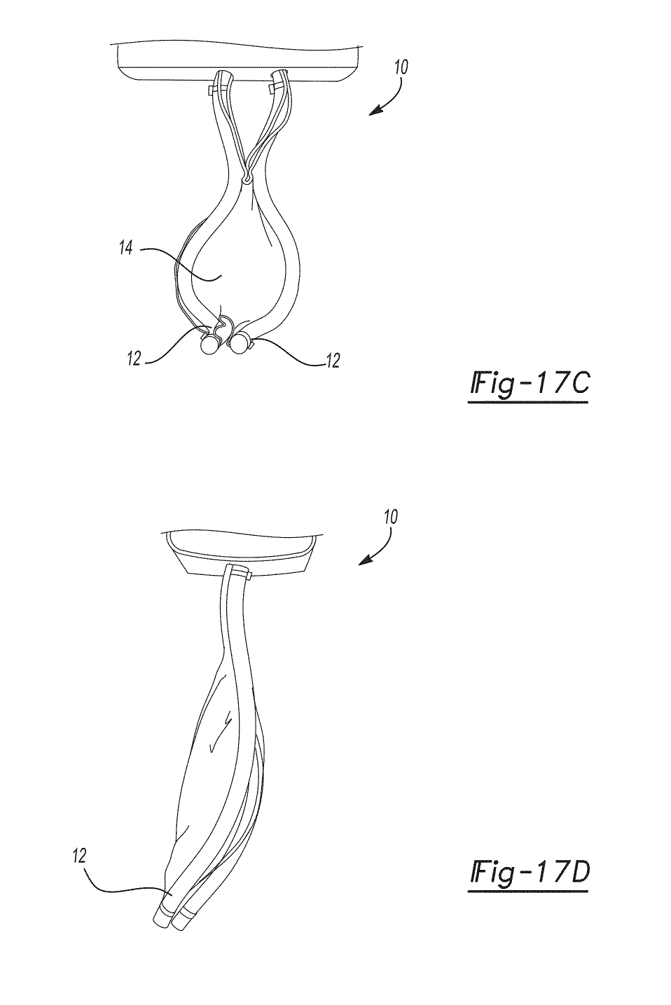

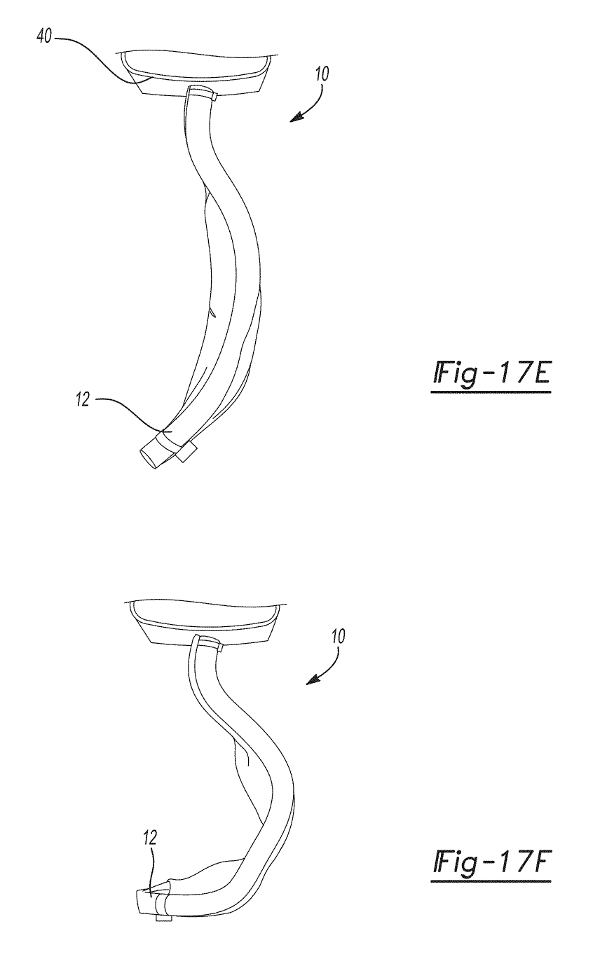

In previous research, this is accomplished with a glass-fiber reinforced polymer rod and woven or knitted textiles. When the boundary is replaced by pneumatic actuators, the result is a multi-state pneumatic/textile hybrid system, where actuation of the rail allows for the generation of an array of formal and structural configurations (as seen in FIGS. 17A-17F).

The present teachings employ fundamental strategies for controlling motion behavior of a pneumatic actuator through the articulation of a seamless knitted constraint. The knitted constraint poses unique opportunities over a conventional soft actuator in being able to produce differentiation in shape, material and structural behavior within a single unit. Weight is an important quality as well, where actuation at pressures up to 100 psi can be accomplished with extremely thin-walled conventional silicone tubing. The present teachings involve, though, exploration at the finest levels of material construction in the fibers, yarns, stitch structure, and methodologies for knit manufacturing. Thus, the present teachings explore an exhaustive array of variants in these 1^{st}, 2^{nd} and 3^{rd} order parameters.

The aggregation of motion within a single actuator and integration of multiple actuators within a single system opens up unique opportunities. The proximity between actuators can be designed to, in some embodiments, activate and transform the geometry of a material spanning between the actuators. In another embodiment, actuators can be designed adjacent to each other. This would allow for a full spectrum of forward and reverse actuation. Bending, un-bending and reverse bending is possible all by controlling the balance of pneumatic pressure. This means, for instance, that what is typically an un-loaded state, unable to respond to external loads, can actually be loaded by having an equal balance of pressure between the two adjacent actuators.

The current system of the present teachings links each snapshot of the actuator with its current pressure. But, analysis of geometry and rotation is done manually. Scale is a critical issue when considering the potential as an architectural system. While the multi-gauging technique is clamped based on the maximum scale and spacing of stitches, the shaping techniques are more extensible and should be generalizable for larger scales.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A knit-constrained actuator system comprising:
a pneumatic actuator system configured to output a pneumatic pressure;
an elastomeric actuator configured to receive and physically respond to the pneumatic pressure; and
a knitted sleeve formed over the elastomeric actuator, the knitted sleeve mechanically constraining the elastomeric actuator, the knitted sleeve being of a predetermined stitch configuration to achieve an actuated motion of the elastomeric actuator.

2. The knit-constrained actuator system according to claim 1 wherein the knitted sleeve comprises a course-wise tubular knot to constrain response of the elastomeric actuator.

3. The knit-constrained actuator system according to claim 1 wherein the knitted sleeve comprises a welt-wise constraint response multi-gauging technique to introduce varied knit densities at an elbow.

4. The knit-constrained actuator system according to claim 1 wherein the elastomeric actuator comprises a silicon tubing.

5. The knit-constrained actuator system according to claim 1 wherein the knitted sleeve being of a predetermined stitch configuration to achieve at least one of linear motion, bending motion, and twisting motion of the elastomeric actuator.

6. The knit-constrained actuator system according to claim 1 wherein the knitted sleeve being of a predetermined stitch configuration to achieve multiaxial motion of the elastomeric actuator.

7. The knit-constrained actuator system according to claim 1 wherein the knitted sleeve being of a predetermined stitch configuration to achieve motion of the elastomeric actuator greater than 360 degree.

8. The knit-constrained actuator system according to claim 1 wherein the knitted sleeve comprises a weft knitted sleeve.

9. The knit-constrained actuator system according to claim 1 wherein the knitted sleeve comprises an extensible region and a restricting region, the extensible region having a greater density of stitches relative to the restricting region.

10. The knit-constrained actuator system according to claim 1 wherein the knitted sleeve comprises a backbone, the backbone having a series of stitches oriented in a circumferential direction of the knitted sleeve to generate an actuated bending motion.

11. The knit-constrained actuator system according to claim 1 wherein the knitted sleeve comprises a plurality of different yarns.

12. The knit-constrained actuator system according to claim 1 wherein the knitted sleeve comprises a seamless configuration.

13. The knit-constrained actuator system according to claim 1 wherein the pneumatic actuator system comprising an on/off valve and a proportional valve for outputting the pneumatic pressure.

14. A knit-constrained actuator system comprising:
a pneumatic actuator system configured to output a pneumatic pressure;
at least two elastomeric actuators each configured to receive and physically respond to the pneumatic pressure; and
a seamless knitted sleeve formed over the at least two elastomeric actuators, the seamless knitted sleeve mechanically constraining the at least two elastomeric actuators, the knitted sleeve being of a predetermined stitch configuration to achieve an actuated motion of the at least two elastomeric actuators.

15. The knit-constrained actuator system according to claim 14 wherein the at least two elastomeric actuators are configured to conform a portion of the seamless knitted sleeve extending there between.

16. The knit-constrained actuator system according to claim 14 wherein the at least two elastomeric actuators are configured to achieve a forward and reverse actuated motion of the seamless knitted sleeve.

17. The knit-constrained actuator system according to claim 14 wherein the seamless knitted sleeve comprises a course-wise tubular knot to constrain response of the at least two elastomeric actuators.

18. The knit-constrained actuator system according to claim 14 wherein the seamless knitted sleeve comprises a welt-wise tubular knot to constrain response of the at least two elastomeric actuators.

19. The knit-constrained actuator system according to claim 14 wherein the seamless knitted sleeve being of a predetermined stitch configuration to achieve at least one of linear motion, bending motion, and twisting motion of the elastomeric actuator.

20. The knit-constrained actuator system according to claim 14 wherein the seamless knitted sleeve being of a predetermined stitch configuration to achieve multiaxial motion of the elastomeric actuator.
